(19) United States
(12) Patent Application Publication
(10) Pub. No.: US 2022/0286073 A1
(43) Pub. Date: Sep. 8, 2022

(54) TRACTION MOTOR HAVING A SWITCH FOR CHANGING THE NUMBER OF TURNS

(71) Applicant: NIDEC-DriveXpert GmbH, Ilmenau (DE)

(72) Inventor: Robert REICHERT, Ilmenau (DE)

(21) Appl. No.: 17/636,688

(22) PCT Filed: Aug. 21, 2020
(86) PCT No.: PCT/EP2020/073459

§ 371 Date: Feb. 18, 2022

(30) Foreign Application Priority Data
Aug. 21, 2019 (DE) 10 2019 122 465.9

(51) Int. Cl. H02P 25/08; H02P 25/18; H02K 3/28; B60L 15/20

(52) U.S. Cl. CPC H02P 25/08; H02P 25/188; H02K 3/28; B60L 15/20; B60L 2220/18

(57) ABSTRACT

A traction motor with a switched reluctance motor of a motor vehicle includes a ferromagnetic rotor, a stator with stator poles each including a winding with at least one winding strand, and at least two winding strands of a stator pole or at least two winding strands arranged on diametrically opposite stator poles being assigned to a motor phase, the at least two winding strands being between a first supply line connected to a DC voltage source and a second supply line connected to a ground connection, and each winding strand being assigned an upper electronic switch and a lower electronic switch each having a freewheeling diode arranged in parallel, and a controller to control the electronic switches of the circuits as a function of a position of the rotor.

### CROSS REFERENCE TO RELATED APPLICATIONS

This is a U.S. national stage of PCT Application No. PCT/EP2020/073459, filed on Aug. 21, 2020, and with priority under 35 U.S.C. § 119(a) and 35 U.S.C. § 365(b) being claimed from German Application No. 10 2019 122 465.9, filed Aug. 21, 2019, the entire disclosures of which are hereby incorporated herein by reference.

### 1. FIELD OF THE INVENTION

The present disclosure relates to a traction motor of a motor vehicle including a switched reluctance machine and to a method of controlling a circuit of a motor phase of a switched reluctance motor of a traction motor.

### 2. BACKGROUND

Switched reluctance motors are often used as prime movers in electric drive systems because they are inexpensive to use and robust in operation. Usually, an inverter topology with asymmetrical half bridges is used, which is connected to the phases of the motor without a star point. It is also known to use switched reluctance motors in traction motors especially in electric drive systems in an electrically powered vehicle such as an electric car or a hybrid vehicle.

The classic inverter topology for three-phase switched reluctance motors consists of six power switches. It is composed of three independent asymmetrical H-bridges. The upper power switch of each H-bridge in conjunction with the lower diode provides the regulation of the current in the connected winding strand. The lower power switch in conjunction with the upper diode enables rapid decommutation against the full DC supply voltage during the transition from one motor strand to another.

When designing switched reluctance engines, a compromise must be made between high torque in the lower speed range and maximum speed. For traction engines in particular, however, it is desirable to optimize the engine in the speed range both for city operation of the motor vehicle and for highway operation.

From the disclosure of document DE 43 30 386 A1, a switched reluctance motor is known which has a tap located in the middle of the phase winding, which is connected on the one hand to a first pole via a freewheeling half-switch and on the other hand to the other pole of the DC voltage source via an additional switching transistor. When a predetermined torque is reached, half the number of pole windings is disconnected by the switch so that a higher torque can be achieved.

### SUMMARY

Example embodiments of the present disclosure to provide traction motors each including a switched reluctance machine which can simultaneously be improved in a simple manner in two speed ranges.

An example embodiment of the present disclosure provides a traction motor with a switched reluctance motor of a motor vehicle which includes a ferromagnetic rotor, a stator with stator poles each including a winding with at least one winding strand, two winding strands of a stator pole or two winding strands arranged on diametrically opposed stator poles are assigned to a motor phase, the two winding strands are arranged between a first supply line connected to a DC voltage source and a second supply line connected to a ground connection, and each winding strand includes an upper electronic switch and a lower electronic switch with a corresponding freewheeling diode arranged in parallel, and a controller to control the upper electronic switches and the lower electronic switch of the circuits depending on a position of the rotor. The at least two winding strands of a motor phase are connected in a common circuit via a cross branch in such a way that the at least two winding strands of a motor phase are switchable between a parallel connection and series connection by the control of the electronic switches.

The two winding strands of a motor phase are connected asymmetrically.

The fact that the winding strands can be operated both in parallel connection and in series connection only by switching the electronic switches enables the motor to be optimized for both city operation and highway operation of the motor vehicle. The number of turns can be varied by a factor of two for the same number of turns per winding strand. However, it can also be provided that the number of turns per winding strand is different.

Preferably, the controller includes a microprocessor or an FPGA, which causes a switchover from series connection to parallel connection after the reluctance motor reaches a predetermined rotational speed. At high speeds, the winding strands are thus preferably operated in parallel connection. It is also conceivable to make the switching dependent on the torque of the reluctance motor or on a predefined speed gradient.

It is advantageous if two winding strands of a motor phase define a winding strand pair, such that one of the winding strands of a winding pair is arranged in an asymmetrical half bridge including the two electronic switches and the two freewheeling diodes and the second winding strand is arranged in a symmetrical half bridge as used in rotating field machines. In other words, parallel to the asymmetrical half-bridge, a third, upper electronic switch and a fourth, lower electronic switch are arranged in series between the two supply lines, a freewheeling diode is associated with the third and fourth electronic switches, and wherein the third and fourth electronic switches are connected to the freewheeling diodes via a center tap respectively between the electronic switches and the freewheeling diodes. The two nodes defined between the two electronic switches and the two freewheeling diodes are connected to a third node between the lower electronic switch of the first winding strand and the first winding strand via the cross branch, with the second winding strand being in the cross branch. By controlling the electronic switches, it is possible to switch between parallel and series connection of the winding strands. Due to the described connection of the two winding strands, no additional electronic components are necessary. The circuit can be scaled as required. With two winding strands per phase, only four electronic switches are provided in total, two per winding strand. The number of electronic switches increases to n+x with n>=x>=2 for n winding strands per phase.

In general, the electronic switches can be, for example, MOSFET switches or bipolar transistors, especially IGBT switches.

Furthermore, a motor vehicle with electric or hybrid drive is provided including at least one traction motor described above with a switched reluctance motor to drive at least two motor vehicle wheels.

The traction motor can drive the vehicle wheels via a transmission and a downstream differential, or it can also be provided that each wheel is driven separately by a traction motor.

In addition, a method of controlling a circuit of a motor phase of a switched reluctance motor of a traction motor according to an example embodiment of the present disclosure includes a ferromagnetic rotor, a stator with stator poles, the stator poles each including a winding with at least one winding strand, at least two winding strands of a stator pole or at least two winding strands arranged on diametrically opposed stator poles being assigned to a motor phase, the at least two winding strands being arranged between a first supply line connected to a DC voltage source and a second supply line connected to a ground connection, and each winding strand being assigned an upper electronic switch (high-side) and a lower electronic switch (low-side) each including a freewheeling diode arranged in parallel, and a controller to control the electronic switches of the circuits in dependency of the position of the rotor, the at least two winding strands of a motor phase being connected in a common circuit via a cross branch.

Two winding strands of a motor phase define a winding strand pair, with one of the winding strands of a winding pair being arranged in an asymmetrical half bridge including the two electronic switches and the two freewheeling diodes, and a second winding strand being in a symmetrical half bridge. In parallel with the asymmetrical half-bridge, a third and a fourth electronic switch are arranged in series between the supply lines, with freewheeling diodes being associated with the third and fourth electronic switches. The third and fourth electronic switches are connected to the freewheeling diodes via a center tap in each case between the electronic switches and the freewheeling diodes, and two nodes defined between the two electronic switches and the two freewheeling diodes are in turn connected to a third node between the lower electronic switch of the first winding strand and the first winding strand via the cross branch, the second winding strand being in the cross branch. In this case, the method includes operating the circuit in series connection by turning on an upper electronic switch of the first winding strand and a lower, fourth electronic switch and turning off the other two electronic switches and allowing current to flow through the upper electronic switch into the first winding strand and then through the cross branch and the second winding strand and the fourth electronic switch so that the winding current of both winding strands connected in series increases, or operating the circuit in parallel with the two upper electronic switches and the lower electronic switch associated with the first winding strand turned on and the lower, fourth electronic switch turned off so that current flows in parallel through the two upper electronic switches, the two winding strands, and then through the lower electronic switch of the first winding strand.

The number of windings can thus be varied by switching the electronic switches of the H-bridges on and off. The number of turns per winding can be the same or different, depending on the application. If the windings are connected in series, a higher induced flux and thus a higher torque is made possible. With a parallel connection, on the other hand, the inductance is reduced and thus also the induced reverse voltage.

Preferably, the controller includes a microprocessor or an FPGA, which causes a switchover from series connection to parallel connection after the reluctance motor reaches a predetermined speed. At high speeds, the winding strands are thus preferably operated in parallel connection. It is also conceivable to make the switching dependent on the torque of the reluctance motor or on a predefined speed gradient.

The above and other elements, features, steps, characteristics and advantages of the present disclosure will become more apparent from the following detailed description of the example embodiments with reference to the attached drawings.

### BRIEF DESCRIPTION OF THE DRAWINGS

Preferred example embodiments of the disclosure are explained in more detail below with reference to the drawings. Identical or functionally identical components are provided with the same reference signs across the figures.

FIG. 1 shows a circuit arrangement of a symmetrical connection of one phase of a switchable reluctance machine of a traction motor in a series connection according to an example embodiment of the present disclosure.

FIG. 2 shows a circuit arrangement of the circuit of FIG. 1 in parallel connection.

FIG. 3 shows a circuit arrangement of an asymmetrical connection of a phase of a switchable reluctance machine of a traction motor in a series connection according to an example embodiment of the present disclosure.

FIG. 4 shows a circuit arrangement of the circuit of FIG. 3 in parallel connection.

### DETAILED DESCRIPTION

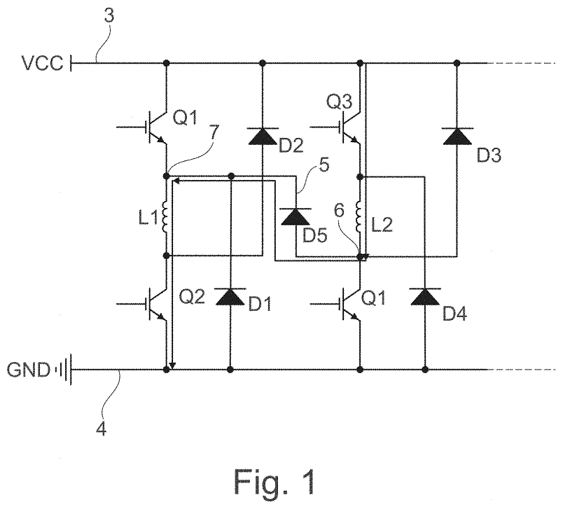

FIGS. 1 to 4 show a circuit arrangement of a multiphase reluctance machine of a traction motor, of which only a single phase is shown for clarity. Each phase has at least two winding strands 1,2.

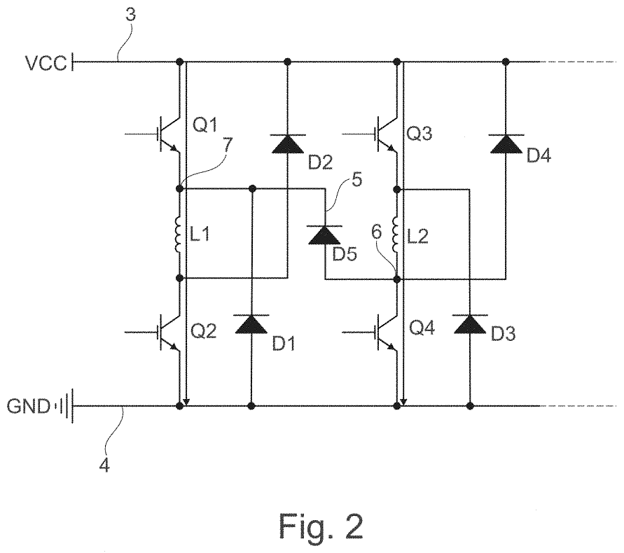

FIGS. 1 and 2 show a first example embodiment. The power controlling element of each winding strand L1,L2 consists of an asymmetrical H-bridge with two electronic switches Q1,Q2,Q3,Q4, in particular power semiconductor switches, which can be supplied, for example, from a DC intermediate circuit, which in turn is supplied with electrical DC voltage by a DC voltage source, for example a traction battery of an electric vehicle. A first supply line 3 is connected to the DC voltage source. A second supply line 4 is connected to a ground connection. The winding strands L1,L2 are arranged between the supply lines 3,4. Each winding strand L1,L2 is assigned an upper electronic switch Q1,Q3 (high-side) and a lower electronic switch Q2,Q4 (low-side). Each electronic switch Q1,Q2,Q3,Q4 is assigned a freewheeling diode D1,D2,D3,D4, each of which is connected in parallel with the corresponding electronic switch Q1,Q2,Q3,Q4, so that when the electronic switches Q1,Q2,Q3,Q4 of a winding strand L1,L2 are switched off, the current flows via the two freewheeling diodes D1,D2,D3,D4. The at least two asymmetrical H-bridges of one phase are connected to each other. A cross branch 5 is provided for this purpose between two asymmetrical H-bridges, in which a diode D5 is arranged. Diode D5 is polarized in the forward direction with respect to the DC voltage source, opposite to the freewheeling diodes D1,D2,D3,D4. The cross branch 5 extends from a first connection point 6 of a first winding strand L2 with a lower electronic switch Q4 and an upper freewheeling diode D3 to a second connection point 7 of a second winding strand L1 with an upper electronic switch Q1, wherein a lower freewheeling diode D1 is arranged in parallel to the lower electronic switch Q2 between the diode D5 and the second connection point 7 and the second supply line 4.

The diode D5 allows switching between series and parallel connection of the winding strands L1,L2 by the electronic switches Q1,Q2,Q3,Q4.

FIG. 1 shows the series connection of the winding strands L1,L2 with the symmetrical connection described above. The arrows symbolize the current flow. In this state, the lower electronic switch Q4 of the first winding strand L2 and the upper electronic switch Q1 of the second winding strand L1 are switched off and the other two electronic switches Q3,Q2 are switched on. The current flows through the first winding strand L2, the cross branch 5 and through the second winding strand L1, so that the winding current of both series-connected winding strands L1,L2 increases. If, on the other hand, all four electronic switches Q1,Q2,Q3,Q4 are switched on, as shown in FIG. 2, the current flows in parallel through the two winding strands L1,L2.

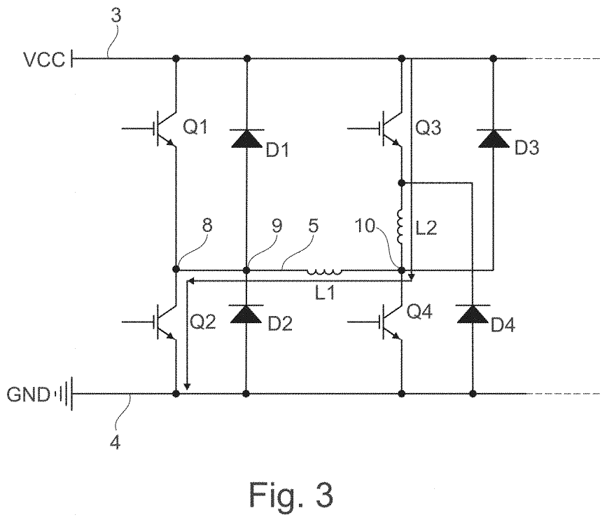

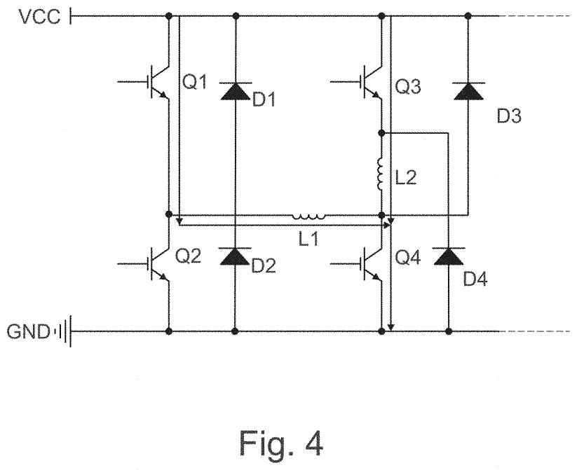

FIGS. 3 and 4 show a second example embodiment with an asymmetrical connection of the phase. A first winding strand L2 is arranged as described before with two electronic switches Q3,Q4 and two freewheeling diodes D3,D4 between the supply lines 3,4 in an asymmetrical half bridge. Parallel to this arrangement, a symmetrical half-bridge with a second winding strand L1 is provided. In this symmetrical half-bridge, a third and a fourth electronic switch Q1,Q2 are arranged in series between the supply lines 3,4, each of these two electronic switches Q1,Q2 being associated with a freewheeling diode D1,D2. The third and fourth electronic switches Q1,Q2 are connected to the freewheeling diodes D1,D2 via a center tap in each case between the electronic switches Q1,Q2 and the freewheeling diodes D1,D2. The resulting two nodes 8,9 are in turn connected to a third node 10 formed between the lower electronic switch Q4 of the first winding strand L2 and the first winding strand L2 via a cross branch 5. The second winding strand L1 is arranged in the cross branch 5.

This asymmetrical connection of the two winding strands L1,L2 allows switching between series connection and parallel connection of the winding strands L1,L2 by the electronic switches Q1,Q2,Q3,Q4. FIG. 3 shows the series connection of the winding strands. In this state, an upper electronic switch Q3 of the first winding strand L2 and a lower, fourth electronic switch Q2 are switched on and the other two electronic switches Q1,Q4 are switched off. The current flows through the upper electronic switch Q3 into the first winding strand L2 and then through the cross branch 5 or second winding strand L1 and the fourth electronic switch Q2, so that the winding current of both series-connected winding strands L1,L2 increases. In another circuit state, as shown in FIG. 4, the two upper electronic switches Q1,Q3 and the lower electronic switch Q4 associated with the first winding strand L2 are turned on. The lower, fourth electronic switch Q2 is switched off. The current flows in parallel through the two upper electronic switches Q1,Q3, the two winding strands L1,L2 and then through the lower electronic switch Q4 of the first winding strand L2. For the asymmetrical arrangement, only a total of four diodes are required for two winding strands.

The winding of a phase of the machine has two or more winding strands arranged symmetrically around the circumference of the stator and wound on protruding poles. The at least two winding strands that make up a phase winding are interconnected as previously described, so that they can be connected in series or in parallel.

The number of windings of the winding strands can be different. In the context of the disclosure, the winding strands may also be pole winding pairs, in which case the winding strands have an equal number of windings. In this case, the stator pole winding pairs of each pair of opposite stator poles are connected.

In general, the electronic switches can be, for example, MOSFET switches or bipolar transistors, especially IGBT switches.

Switching from series connection to parallel connection is preferred when a nominal speed is exceeded, but this can also be made dependent on the speed gradient or the load. If the winding strands are connected in series, a higher induced flux and thus a higher torque is made possible. With a parallel connection, on the other hand, the inductance is reduced and thus also the induced counter voltage.

For traction engines where a wide speed band and high starting torque are required, the ratio of speed band, starting torque and engine volume can thus be improved. The engine can simultaneously be optimized for two speed ranges for city and highway operation. Furthermore, this also increases efficiency in the lower speed range, which accounts for a double-digit share in motor vehicle driving cycles.

For high power applications where the electrical switches are doubled to provide the required power, the electrical switches can be used to implement the previously described interconnection of the winding strands without additional switches.

The symmetrical connection is particularly suitable for systems with high safety requirements, as it offers a high level of redundancy. In the event of failure of one winding strand, the remaining phase can be operated, enabling emergency operation with half the phase power. The asymmetrical connection, on the other hand, is characterized by higher efficiency and low costs, since the additional diode can be dispensed with.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-12. (canceled)

13. A traction motor of a motor vehicle with a switched reluctance motor, the traction motor comprising:
a ferromagnetic rotor;
a stator with stator poles each including a winding with at least one winding strand, and two winding strands of a single one of the stator poles or two winding strands arranged on diametrically opposed ones of the stator poles are assigned to one motor phase;
a first supply line connected to a DC voltage source and a second supply line connected to a ground terminal, the two winding strands being between the first supply line and the second supply line;
first through fourth electric switches, including an upper electronic switch and a lower electronic switch, each associated with one of the two winding strands and including a freewheeling diode arranged in parallel;
a controller to control the first through fourth electronic switches of the circuits depending on a position of the rotor, the two winding strands being interconnected in a common circuit via a cross branch in such a way that the at least two winding strands are switchable between a parallel circuit and series circuit by the control of the first through fourth electronic switches; and
the two winding strands of a motor phase are connected asymmetrically.

14. The traction motor according to claim 13, wherein the controller is configured or programmed to, after a predetermined speed of the reluctance motor has been reached, cause a switchover from the series circuit to the parallel circuit.

15. The traction motor according to claim 13, wherein
the two winding strands define a winding strand pair, one of the winding strands of a winding pair being arranged in an asymmetrical half bridge including the third and fourth electronic switches and two of the freewheeling diodes and, parallel to this arrangement, a symmetrical half-bridge in which the first and second electronic switches are arranged in series between the first and second supply lines, the first and second electronic switches each being assigned ones of the freewheeling diodes;
the first and second electronic switches are connected to ones of the freewheeling diodes via a center tap with two nodes defined thereby being connected to a third node between the fourth electronic switch of a first winding strand of the winding pair and the first winding strand, via the cross branch, a second winding strand of the winding pair being arranged in the cross branch.

16. A motor vehicle comprising an electric or hybrid drive comprising at least one of the traction motor according to claim 13 with a switched reluctance motor to drive at least two motor vehicle wheels.

17. A method of controlling a circuit of a motor phase of a switched reluctance motor of a traction motor, the switched reluctance motor including a ferromagnetic rotor, a stator with stator poles each including a winding with at least one winding strand, and two winding strands of one of the stator poles or two winding strands on diametrically opposed ones of the stator poles are associated with a motor phase, the two winding strands are arranged between a first supply line connected to a DC voltage source and a second supply line connected to a ground connection, first through fourth electric switches, including an upper electronic switch and a lower electronic switch, each associated with one of the two winding strands and including a freewheeling diode arranged in parallel, and a controller to control the first through fourth electronic switches of the circuits depending on a position of the rotor, the two winding strands being interconnected in a common circuit via a cross branch, the two winding strands define a winding strand pair, one of the winding strands of a winding pair being arranged in an asymmetrical half bridge including the third and fourth electronic switches and two of the freewheeling diodes and, parallel to this arrangement, a symmetrical half-bridge in which the first and second electronic switches are arranged in series between the first and second supply lines, the first and second electronic switches each being assigned ones of the freewheeling diodes, and the first and second electronic switches are connected to ones of the freewheeling diodes via a center tap with two nodes defined thereby being in turn connected to a third node between the fourth electronic switch of a first winding strand of the winding pair and the first winding strand, via the cross branch, a second winding strand of the winding pair being arranged in the cross branch, and the method comprising:
operating the circuit in series connection of the two winding strands, such that a third electronic switch of the first winding strand and the second electronic switch are switched on and the first and fourth electronic switches are switched off and the current flows via the third electronic switch into the first winding strand and then via the cross branch and the second winding strand and the second electronic switch so that a winding current of the two winding strands increases; or
operating the circuit in parallel connection of the two winding strands by selective switching on and off of the first through fourth electronic switches, such that the first and third upper electronic switches and the fourth electronic switch assigned to the first winding strand are switched on and the second electronic switch is turned off, so that the current flows in parallel through the first and third electronic switches, the two winding strands and then through the fourth electronic switch of the first winding strand.

18. The method according to claim 17, further comprising:
when a predetermined speed of the reluctance motor is reached, driving the circuit in parallel connection of the winding strands.
